(19) United States
(12) Patent Application Publication
(10) Pub. No.: US 2016/0127122 A1
(43) Pub. Date: May 5, 2016

(54) QUADRICORRELATOR CARRIER FREQUENCY TRACKING

(71) Applicant: MaxLinear, Inc., Carlsbad, CA (US)

(72) Inventor: Tommy Yu, Orange, CA (US)

(21) Appl. No.: 14/932,438

(22) Filed: Nov. 4, 2015

Related U.S. Application Data
(60) Provisional application No. 62/075,039, filed on Nov. 4, 2014.

(51) Int. Cl. H04L 7/033; H04B 7/185

(52) U.S. Cl. CPC H04L 7/0332; H04B 7/18513

(57) ABSTRACT

Systems and methods are provided for correcting frequency drift in satellite receivers based on quadricorrelator carrier frequency tracking. An intermediate frequency corresponding to a received satellite signal may be converted to a digital baseband signal. Frequency related information may be obtained based on quadricorrelator carrier frequency tracking of the digital baseband signal, and the information may be used in generating a quadricorrelator corrected channel. The quadricorrelator corrected channel may converge to the centroid of its spectrum. Thus, the advanced quadricorrelator frequency tracking may allow tracking and correcting frequency drift during baseband signal processing.

### CLAIM OF PRIORITY

This patent application makes reference to, claims priority to and claims benefit from U.S. Provisional Patent Application Ser. No. 62/075,039, filed Nov. 4, 2014. The above identified application is hereby incorporated herein by reference in its entirety.

### TECHNICAL FIELD

Aspects of the present disclosure relate to communication, particularly satellite communications and tracking frequency drift in satellite receivers. More specifically, certain implementations of the present disclosure relate to methods and systems for a quadricorrelator carrier frequency tracking.

### BACKGROUND

Conventional systems and methods, if any existed, for tracking frequency drift during satellite communications, can be costly, inefficient, and/or ineffective. Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for quadricorrelator carrier frequency tracking, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example satellite communication system.

FIG. 2 illustrates example downlink signal processing components of a satellite communication system.

FIG. 3 illustrates an example enhanced LNB downlink signal processing component, in accordance with example embodiments of this disclosure.

FIG. 4 illustrates an example advanced quadricorrelator carrier frequency tracking loop in a frequency tracking component, in accordance with example embodiments of this disclosure.

FIG. 5 illustrates a flow chart of example advanced quadricorrelator carrier frequency tracking, in accordance with example embodiments of this disclosure.

FIG. 6 illustrates an example carrier frequency spectrum output offset drift of a traditional or legacy LNB.

FIG. 7 illustrates an example improved carrier frequency spectrum output of an LNB with advanced quadricorrelator carrier frequency tracking, in accordance with example embodiments of this disclosure.

### DETAILED DESCRIPTION OF THE INVENTION

As utilized herein the terms “circuits” and “circuitry” refer to physical electronic components (e.g., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

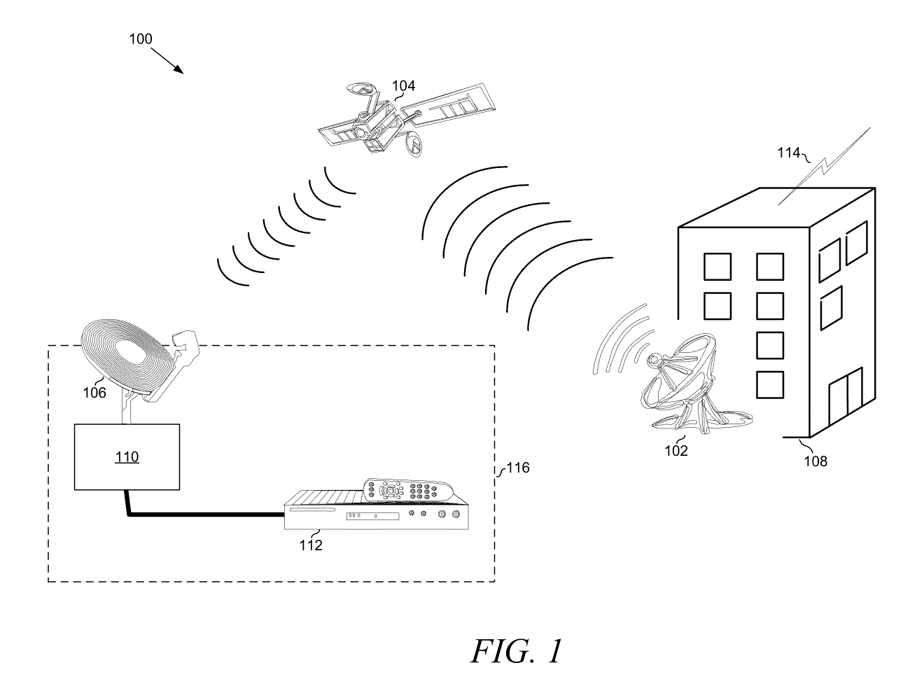

FIG. 1 illustrates an example satellite communication system. Shown in FIG. 1 is a satellite communication system 100.

The satellite communication system 100 may correspond to and/or be part of a satellite network, such as a satellite television (TV) based network. Satellite networks may provide communication infrastructure, including one or more satellite nodes, used for such purposes as satellite television (TV) broadcasts, military and space surveillance, navigation, scientific research, and many types of fixed and mobile global communications. While various aspects of the present disclosure and/or embodiments in accordance therewith may be described, for purposes of simplicity and ease of reference, in relation to satellite television (TV), the disclosure is not so limited, and various features of the described embodiments may be applied to other receivers having a diversity of purposes and/or applications.

With respect to satellite TV networks, customers nowadays may receive their programming through Direct Broadcast Satellite (DBS) providers (e.g., DirecTV™, DISH Network™, etc.). The provider selects programs and broadcasts them to subscribers as a set package, bringing dozens or even hundreds of channels to a TV. Digital TV broadcast satellites may generally transmit programming in particular frequency ranges—e.g., Ku frequency range (11.7 GHz to 14.5 GHz) or Ka frequency range (26.5 GHz to 40 GHz).

Satellite networks may comprise one or more satellites as well as uplink and/or downlink components for transmitting and/or receiving signals from/to the satellites. For example, uplink components involved in a Direct to Home (DTH) or Direct Broadcasting (DBS) satellite setup, such as the satellite communication system 100, may comprise a broadcast center 108, content (e.g., programming) sources (not shown) providing content to the broadcast center 108 over a communications link 114 (e.g., wired and/or wireless), and an uplink satellite antenna (i.e., dish) 102 for transmitting that content from the broadcast center 108 to a satellite 104. The broadcast center 108 may be the central hub of the satellite communication system 100. At the broadcast center 108, the provider receives signals via communications link(s) 114 from the various content sources, and transmits a broadcast signal to the satellite 104. The content sources may be the channels that provide programming content for broadcast by the content provider from the broadcast center 108. The provider does not create original programming. The content provider pays other companies (for example, HBO, ESPN, etc.) for the right to broadcast their content via the satellite 104. Thus, the content provider performs as a broker between the viewer and the actual content sources.

The satellite 104 receives the signals from the broadcast center 108 and rebroadcasts them to Earth. As shown in FIG. 1, the satellite 104 receives the content from the uplink satellite antenna 102 and re-transmits it to downlink signal processing arrangement 116. For example, the satellite 104 may transmit to a downlink satellite antenna (i.e., dish) 106 coupled to an LNB 110. The LNB 110 outputs an appropriate signal to a satellite receiver/decoder (i.e., set top box) 112 that provides user interface and channel selection inside a home. In this regard, an appropriate signal for a satellite receiver/decoder 112 may provide an amplified carrier tunable signal modulated with channel information.

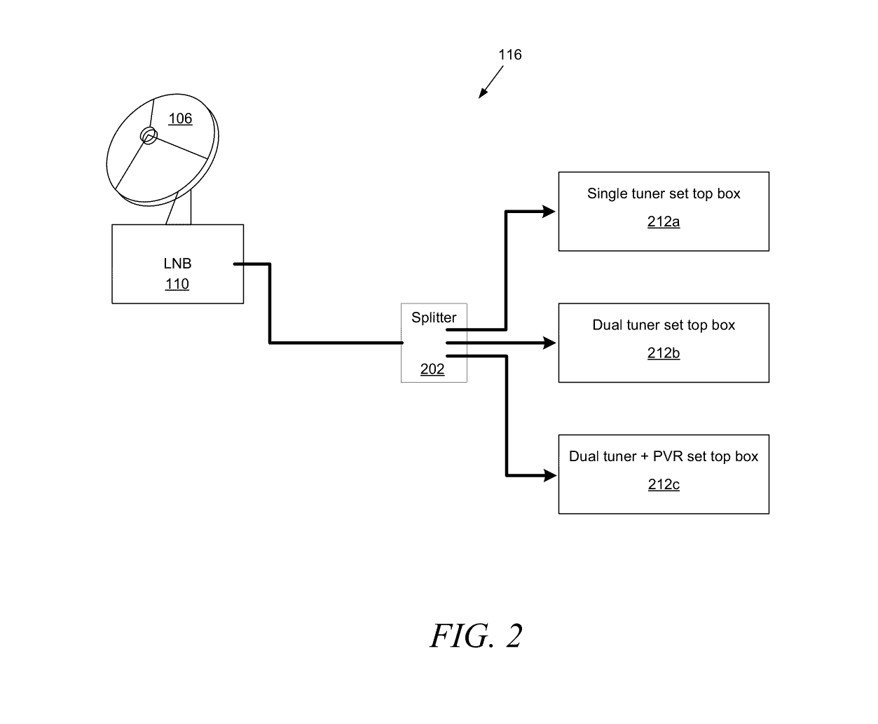

The downlink signal processing arrangement 116 receives the signals that have been rebroadcast to Earth. The viewer's downlink satellite antenna 106 picks up the signals from the satellite 104 (or multiple satellites in the same part of the sky) and passes them to the LNB 110. The LNB 110 down-converts the received signals and filters individual channels from the signals, which it provides to the satellite receiver/decoder 112 inside the user's home. The satellite receiver/decoder 112 processes the output of the LNB 110 and provides it to a standard TV. The downlink signal processing arrangement 116 are detailed in FIG. 2.

In some instances, issues may arise with use of satellite communications. For example, frequency drift may occur in satellite receivers. Frequency drift is an unintended and generally arbitrary offset of an oscillator from its nominal frequency. In this regard, frequency drift is traditionally measured in Hertz (Hz). Frequency stability can be regarded as the absence (or a very low level) of frequency drift. Causes of frequency drift may include component aging, changes in temperature, or non-ideal voltage regulators, which control the bias voltage to the oscillator. For example, in many current or legacy designs for satellite receiver Radio Frequency (RF) down-converters may typically use Dielectric Resonator Oscillators (DROs) for good phase noise performance and low cost. However, the DRO output frequency is not stable, drifting as much as +/−5 MHz causing increased output channel spacing needs that limit the number of channels available at the output of a receiver.

Accordingly, in various embodiments in accordance with the present disclosure, frequency drift may be addressed in satellite receivers in a manner that optimizes performance (e.g., increase frequency stability). In particular, satellite receivers may be configured to accurately track frequency drift in order to prevent channel overlap, reduce output channel spacing needs, and increase the number of available output channels. As noted above, a downlink satellite signal path may comprise a Low Noise Block (LNB) having an RF down-converter section and an L-band intermediate section. The RF down-converter section translates (i.e., down-converts) the received satellite signal from Ku-band, Ka-band or C-band radio frequencies to L-band Intermediate Frequencies (IF), that can then be converted to baseband frequencies. Current RF down-converter designs depend on DROs to produce the L-band IF translation. In order to acquire a downlink satellite signal of appropriate quality for baseband demodulation, frequency drifts introduced by the DRO should be tracked and corrected.

For example, in a traditional satellite receiver system, the L-Band IF output channel bandwidth space is widened to accommodate the DRO frequency drift so that individual channels do not overlap or cause interference with neighboring channels. As a result, the number of available output channels is limited. For example, a typical satellite transponder having 20 Msym/sec data rate occupies 24 MHz of bandwidth. Adding a 5 MHz guard band between transponder channels, the channel bandwidth spacing is 29 MHz. Due to DRO frequency drift, the post RF down-conversion channel center frequency drift can be as much as +/−5 MHz. Preventing channel overlap from DRO drift adds an additional 10 MHz so that minimum L-Band IF output channel bandwidth spacing now totals 39 MHz. Thus, the number of output channels in an exemplary 950 to 2150 MHz Ku-band RF input signal is limited to approximately 30.

In various implementations in accordance with the present disclosure, each output channel may be filtered and selected from the RF output of a downlink satellite antenna dish, translated to an L-Band IF and converted to digital baseband. As each channel is individually digitally processed, a digital frequency tracking loop based on quadricorrelator architecture may be used to allow the baseband frequency channel output signal to be enhanced and corrected. Further, because a satellite channel is typically based on Quadrature Amplitude Modulation (QAM) and is flat in-band, the quadricorrelator corrected baseband channel signal will converge to the centroid of its spectrum (i.e., the center frequency). Thus, the advanced quadricorrelator frequency tracking loop can track and correct the DRO drift during baseband signal processing. Using the advanced quadricorrelator carrier frequency tracking loop detailed in FIGS. 1-7, the output channel bandwidth spacing can be reduced to 29 MHz, allowing 40 output channels in a 950-2150 MHz bandwidth, or a 33% increase of the number of output channels.

FIG. 2 illustrates example downlink signal processing components of a satellite communication system. Shown in FIG. 2 is an example satellite downlink signal path (e.g., the downlink signal processing arrangement 116 of FIG. 1).

In this regard, as noted above, program content may be transmitted by a geosynchronous, Low Earth Orbit (LEO), or other satellite communication network to users for decoding and playback. The downlink signal processing arrangement 116 may comprise the downlink satellite antenna 106, which may be connected to the LNB 110. The LNB 110, in turn, may be connected to one or more satellite receiver/decoders 212a-212c (e.g., within a home or facility). When the LNB 110 is connected to more than one satellite receiver/decoder, a splitter 202 may distribute the received signal to the various satellite receiver/decoder 212a-212c.

The downlink satellite antenna 106 may be operable to receive signals including content channels modulated on a carrier. The program content channels can be analog content channels or digital content channels. In many systems, data is modulated onto the same carrier using different polarizations. Where digital content channels are modulated onto a carrier, the digital data modulated on the carrier can include a plurality of digital content channels, each of which typically includes at least one video and/or audio stream.

In many instances, a signal containing multiple content channels is transmitted to a satellite 104 from a broadcast center 108 (or uplink facility). A transponder on the satellite 104 then transmits a signal that can be received by a number of downlink satellite antennas 106. The received signal is then passed to the LNB 110, which down-converts the signal to an intermediate frequency (IF). Lastly, this channelized signal is passed to a satellite receiver/decoder 112, such as a set top box, where the signal content is demodulated and decoded (i.e. audio and/or video) for playback.

Thus, information transmitted as relatively high frequency satellite signals, usually as microwave signals, may be converted to similar signals at a much lower frequency compatible with the electronics of the decoding device and/or cabling used to connect an LNB (e.g., the LNB) 110 to a satellite receiver/decoder (e.g., the satellite receiver/decoder 112). A content channel is the digital data modulated onto a carrier frequency within the IF signal. Users may then receive selected content channels as appropriate signals for decoding and use.

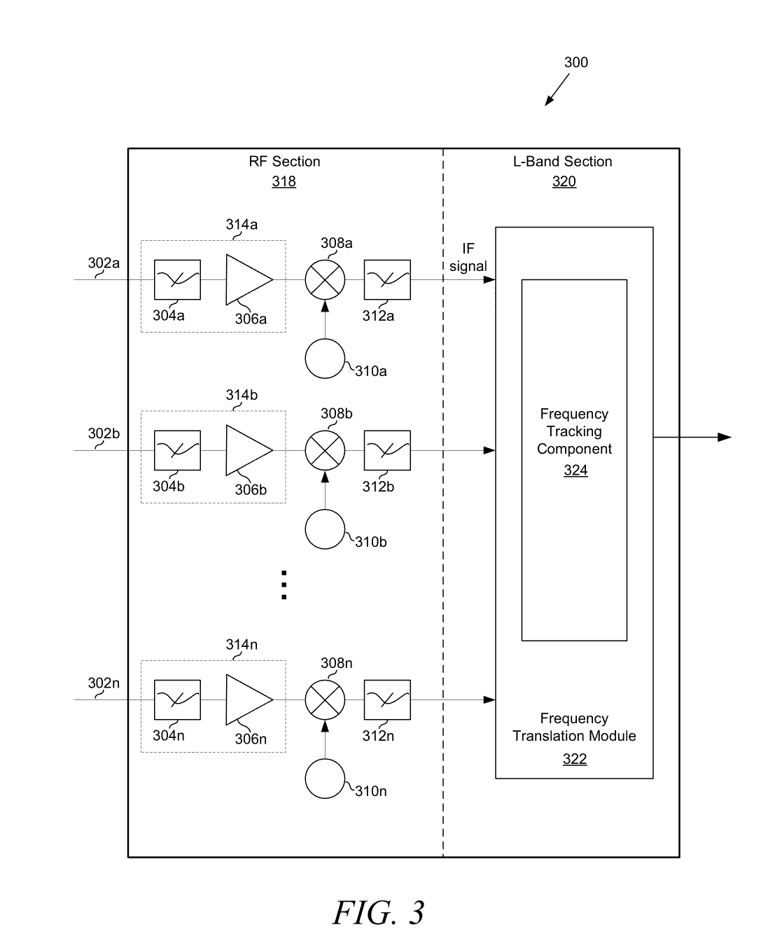

Because RF signals are typically transmitted by a satellite at high frequencies and travel great distances during transmission, a satellite signal is usually weak when received at the downlink satellite antenna 106. The LNB 110 may be used to amplify and convert these high frequency signals to a lower, more manageable frequency. Signals containing content received from a satellite 104 typically include multiple content channels in the frequency band of the carrier signal. The LNB enhanced for Quadricorrelator Carrier Frequency Tracking is detailed in FIG. 3.

FIG. 3 illustrates an example enhanced LNB downlink signal processing component, in accordance with example embodiments of this disclosure. Shown in FIG. 3 is an LNB 300.

The LNB 300 may correspond to the LNB 110 described above, but may be particularly configured (e.g., by incorporating suitable circuitry and/or other hardware or software components) for enhanced performance, particularly with regard to frequency drift, such as by supporting use of quadricorrelator carrier frequency tracking, in accordance with the present disclosure.

The LNB 300 may receive a very low level microwave signal input (e.g., from the downlink satellite antenna 106). The LNB 300 amplifies this weak signal, converts the signal to a lower frequency band (L-band IF), and performs channelization. The channelized converted signal is provided to the satellite receiver/decoder 112. Various types of LNB designs include universal, single band, duel band, multi-band, and polarized architectures. Systems and methods for digital decoding, and selecting modulated data within the satellite signals using digital signal processing are described in United States Patent Application Serial No. 2012/0189084, which is incorporated herein by reference in its entirety.

As used in this disclosure, the expression “Low Noise” may refer to the quality of a first stage input amplifier transistor. The quality is measured in units called Noise Temperature, Noise Figure, or Noise Factor. Both Noise Figure and Noise Factor may be converted to Noise Temperature. A lower Noise Temperature indicates a better received signal. C-band LNBs tend to have the lowest noise temperature performance, while Ka-band LNBs have the highest. The expression “Block” refers to the conversion of a block of microwave frequencies as received from the satellite.

In an example processing scenario in example LNB architecture, received satellite signals 302 may be first processed in RF Section 318 of the LNB 300. For example, the received satellite signals 302 may be first filtered by a band pass filter 304, which allows the intended band of microwave frequencies to pass through. The passed signals are then amplified by a Low Noise Amplifier (LNA) 306 so that they can be down-converted to L-band IF by a mixer 308 coupled to a local oscillator (LO) 310 resonating at the IF. In other words, the output signal of the band pass filter and amplifier stage 314 is combined with a local oscillator 310 signal to generate a wide range of output signals that includes additions, subtractions, and multiples of the desired input signals 302 and the local oscillator 310 frequency.

Amongst this range of LO mixed output products are the difference frequencies between the desired input signal 302 and the local oscillator 310 frequencies. A second band pass filter 312 selects these desired frequencies for output to an L-band section 320 of the LNB 300. Typically the L-band IF output frequency is equal to the RF input frequency minus the local oscillator 310 frequency. In some other inverted cases, the L-band IF output is equal to the local oscillator 310 frequency minus the RF input frequency. Examples of RF input frequency band, LNB local oscillator frequency, and output frequency band are shown below in Table 1 according to a generic LNB having one LNA and one local oscillator frequency for simplicity, although more complex LNBs exist, particularly for satellite TV reception where viewers wish to receive signals from multiple bands, perhaps simultaneously. In some instances, the LNB 300 may be configured to support multiple inputs 302a-302n (e.g., comprising corresponding associated circuitry 304a-304n, . . . , 312a-312n) for parallel processing of multiple or polarized input signal from the downlink satellite antenna 106.

TABLE 1

| Input | | | | |
|---|---|---|---|---|
| frequency | | Local | | |
| band from | | Oscillator | Output L- | |
| satellite | Input band | (LO) | band into | |
| waveguide | GHz | frequency | cable. | Comments |
| C-band | 3.4-4.2 | 5.15 | 950-1750 | inverted output |
| | | | | spectrum |
| | 3.625-4.2 | 5.15 | 950-1525 | inverted output |
| | | | | spectrum |
| | 4.5-4.8 | 5.75 | 950-1250 | inverted output |
| | | | | spectrum |
| | 4.5-4.8 | 5.76 | 960-1260 | NJS8488 |
| | 4.5-4.8 | 5.95 | 1150-1450 | ″ |
| Ku-band | 10.7-11.7 | 9.75 | 950-1950 | |
| | 10.95-11.7 | 10 | 950-1700 | |
| | 10.95-12.15 | 10 | 950-2150 | Invacom SPV- |
| | | | | 50SM |
| | 11.45-11.95 | 10.5 | 950-1450 | |
| | 11.2-11.7 | 10.25 | 950-1450 | |
| | 11.7-12.75 | 10.75 | 950-2000 | Invacom SPV- |
| | | | | 60SM |
| | 12.25-12.75 | 11.3 | 950-1450 | Invacom SPV- |
| | | | | 70SM |
| | 11.7-12.75 | 10.6 | 1100-2150 | |
| Ka-band | 19.2-19.7 | 18.25 | 950-1450 | |
| | 19.7-20.2 | 18.75 | 950-1450 | |
| | 20.2-20.7 | 19.25 | 950-1450 | |
| | 20.7-21.2 | 19.75 | 950-1450 | |
| | 19.7-20.2 | 21.2 | 1000-1500 | Inverted Saorsat |
| | 18.2-19.2 | 17.25 | 950-1950 | Norsat 9000 |
| | 19.2-20.2 | 18.28 | 950-1950 | Norsat 9000 |
| | 20.2-21.2 | 19.25 | 950-1950 | Norsat 9000 |

LNBs 300 used for satellite TV reception utilize DRO stabilized local oscillators. The DRO comprises a dielectric material that resonates at the desired IF. Compared with a quartz crystal, a DRO is relatively unstable, having frequency variations caused mostly by temperature fluctuations. Frequency fluctuations may be as much as +/−5 MHz over the full temperature extremes of the LNB's 300 outdoor operating range. Fortunately, most TV carriers are wide bandwidth so that even with a 5 MHz error, the indoor satellite receiver/decoder 112 will successfully tune the carrier and capture it within its automatic frequency control range. However, the wider bandwidth necessitated by the error factor limits the number of available output channels because extra bandwidth must be allocated to allow for frequency drift error in the down-converted signal.

The output of the second band pass filter(s) 312 may be applied into an L-band Section 320 of the LNB 300. In this regard, the L-band Section 320 of the LNB 300 may comprise suitable circuitry for channelizing and remixing the filtered L-band IF signal(s) generated in the RF Section 318 for appropriate output—e.g., to satellite receiver/decoder 112. Further, the L-band Section 320 may comprise suitable circuitry for handling the frequency drift detection and/or correction.

For example, the L-band Section 320 may comprise a frequency translation module (FTM) 322, to which the output signal(s) of the second band pass filter(s) 312 of the RF Section 318 may be applied. The FTM 322 converts the L-band IF signal from analog to digital in order to perform cross-point switching and channelization to select a desired output channel. In other words, a selected channel is digitized and mixed down to baseband so that it can be enhanced with frequency drift error correction, re-mixed to an appropriate output frequency, and re-converted to an analog signal for output to the receiver/decoder 112.

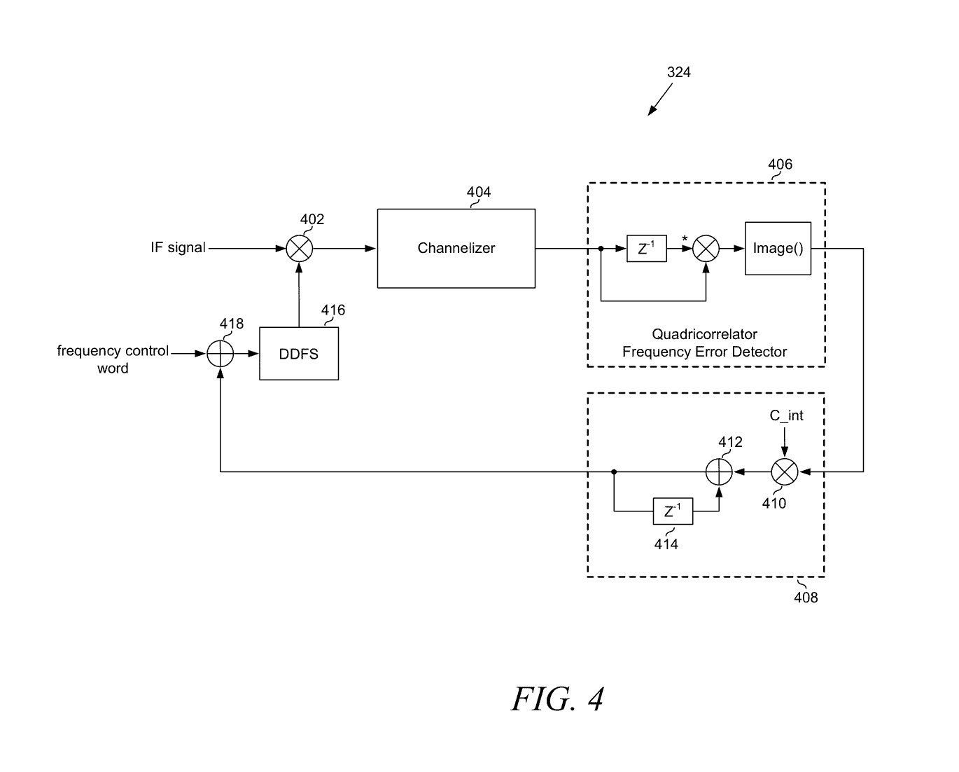

The FTM 322 may comprise a frequency tracking component (FTC) 324, which may be operable to precisely track the carrier's center frequency, to eliminate the DRO frequency drift error so that a maximum number of output channels may be available. For example, using the properties of the digital baseband signal, Phase Lock Loop (PLL) center frequency error correction can be digitally implemented by the FTC 324 of the FTM 322. This center frequency tracking and error correction serves to allow more channels in a given bandwidth, and also prevents channel overlap of neighboring channels. An example implementation of the FTC 324, with advanced quadricorrelator carrier frequency tracking, is detailed in FIG. 4.

FIG. 4 illustrates an example advanced quadricorrelator carrier frequency tracking loop in a frequency tracking component, in accordance with example embodiments of this disclosure. Shown in FIG. 4 is a schematic diagram of FTC 324 (or portion thereof) of FIG. 3, in accordance with an example embodiment.

For example, as illustrated in the example implementation depicted in FIG. 4, the FTC 324 may use error correction information generated by a quadricorrelator frequency error detector 406 and PLL filter 408 for correcting the center frequency in order to drive a direct digital frequency synthesizer (DDFS) 416 before mixing with the satellite receiver/decoder 112 (e.g., tuner or set top box) appropriate output frequency and conversion to analog.

The FTC 324 operates to combine an applied L-band IF signal with error correction information at multiplier 402. The combined signal is channelized by a channelizer 404 and applied to the quadricorrelator frequency error detector 406. The quadricorrelator frequency error detector calculates the centroid of the applied signal. If the applied signal is perfectly centroid, the output of the quadricorrelator 406 is equal to zero. If the applied signal has a positive frequency offset, a positive output value is generated. Likewise, if the applied signal has a negative frequency offset, a negative output value is generated. An example implementation of quadricorrelator frequency error detector 406 is shown in FIG. 4.

The output value of the quadricorrelator 406 is integrated by the PPL 408, forcing the digital frequency tracking loop to converge. The output of the quadricorrelator is mixed with an integration coefficient (C_int) which determines the number of samples for averaging out noise at multiplier 410. In various embodiments, the integration coefficient C_int may be predetermined, automatically selected or user selected. In one example embodiment, the user may select from 16 integration coefficients. Integration and summing by integrator 414 and summer 412 produces a frequency error term.

The frequency error term and frequency control word for channel selection are summed at summer 418. The summed value, representing a corrected center frequency signal, drives a DDFS 416. The output of the DDFS 416 is combined with the applied IF signal at multiplier 402, completing the frequency tracking loop. The completed frequency tracking loop produces a baseband signal having no, or a negligible, residual frequency error. In other words, the baseband signal is frequency dead centered prior to tuner appropriate mixing and analog conversion.

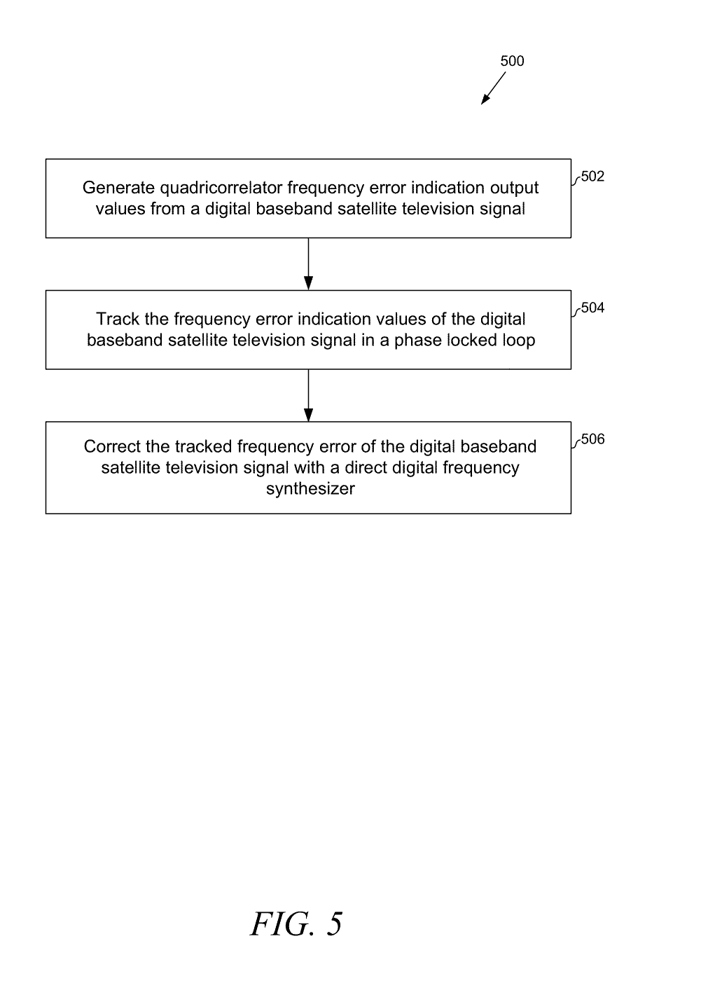

FIG. 5 illustrates a flow chart of example advanced quadricorrelator carrier frequency tracking, in accordance with example embodiments of this disclosure. Shown in FIG. 5 is a flow chart 500 comprising a plurality of example steps (blocks 502-506), which may be performed in a suitable system (e.g., LNB 300) to provide advanced quadricorrelator carrier frequency tracking, in accordance with example embodiments of this disclosure.

In step 502, a quadricorrelator frequency error indication output value may be generated from a digital baseband satellite television signal.

In step 504, the frequency error indication values of the digital baseband satellite television signal may be tracked, such as, for example, by using a phase locked loop.

In step 506, the tracked frequency error of the digital baseband satellite television signal may be corrected with a direct digital frequency synthesizer.

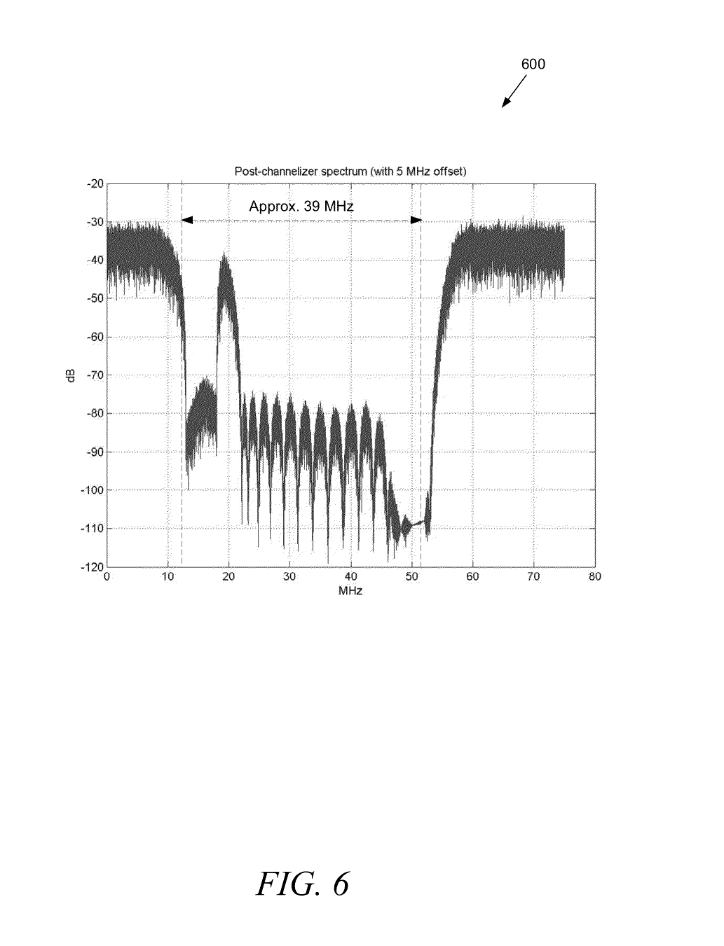

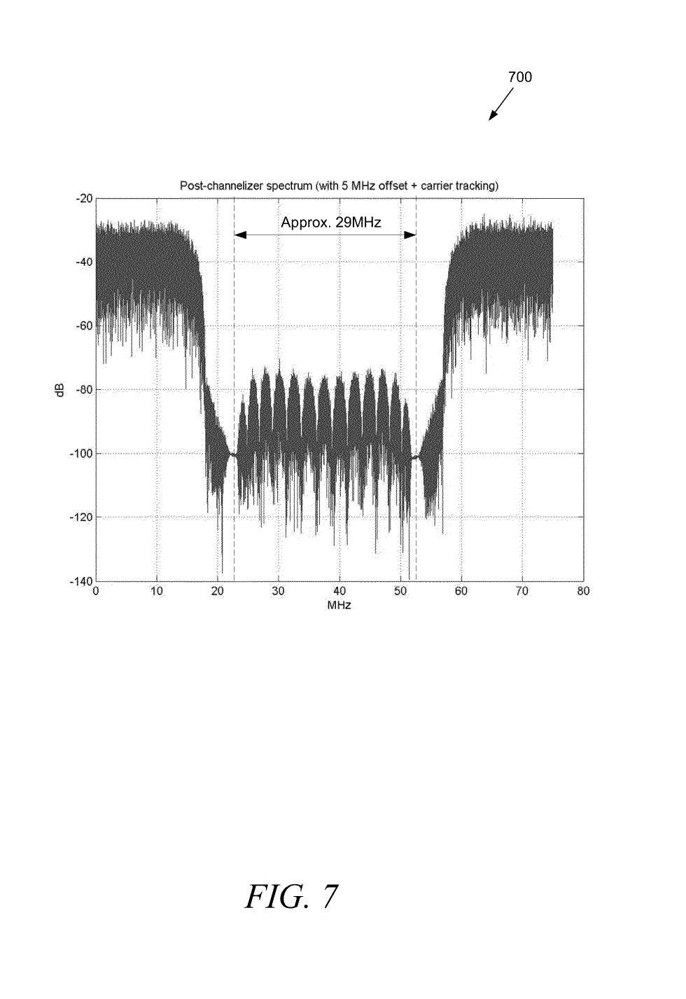

FIGS. 6 and 7 demonstrate example enhancements that may be achieved with example embodiments in accordance with this disclosure. FIG. 6 illustrates an example carrier frequency spectrum output offset drift of a traditional or legacy LNB. Shown in FIG. 6 is graph 600, depicting an example carrier frequency spectrum output of a traditional LNB having channel overlap and offset drift because the LNB does not benefit from advanced quadricorrelator carrier frequency tracking. In this regard, the LNB output spectrum shows approximately 39 MHz of bandwidth occupied by an output channel.

FIG. 7 illustrates an example improved carrier frequency spectrum output of an LNB with advanced quadricorrelator carrier frequency tracking, in accordance with example embodiments of this disclosure. Shown in FIG. 7 is graph 700 depicting carrier frequency spectrum output of an improved LNB, having advanced quadricorrelator carrier frequency tracking, in accordance with example embodiments of the present disclosure. In this case, the LNB output spectrum shows approximately 29 MHz of bandwidth occupied by an output channel. Further, channel overlap and frequency drift are not present, conserving approximately 10 MHz of bandwidth in comparison with the traditional carrier frequency spectrum output shown in FIG. 6.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system, comprising:
a low noise block (LNB) for demodulating satellite signals, the LNB comprising:
a quadricorrelator that is operable to generate center frequency offset indications for a digital baseband channel signal corresponding to a received satellite signal;
a phase locked loop frequency tracker that is operable to produce a frequency error term based on the center frequency offset indications;
a summer operable to sum the frequency error term with a frequency control word to produce a summed value representing a signal having a corrected center frequency; and
a digital frequency synthesizer operable to generate, based on the summed value, a channel signal having a corrected center frequency for output to a satellite receiver/decoder.

2. The system of claim 1, wherein the LNB comprises a channelizer that is operable to select the digital baseband channel signal from the received satellite signal.

3. The system of claim 1, wherein the phase locked loop frequency tracker is operable to precisely track the carrier center frequency of the digital baseband channel signal to eliminate Dielectric Resonator Oscillator (DRO) frequency drift error.

4. The system of claim 1, wherein the quadricorrelator is operable to calculate a centroid of the digital baseband channel signal for determining the center frequency offset indications of the selected digital baseband channel signal.

5. The system of claim 1, wherein the phase locked loop frequency tracker is operable to integrate an output value of the quadricorrelator to force a digital baseband channel signal frequency tracking loop to converge.

6. The system of claim 1, wherein the phase locked loop frequency tracker is operable to combine an output value of the quadricorrelator with a fixed or variable integration coefficient that determines a number of samples for averaging out noise in the digital baseband channel signal.

7. The system of claim 1, wherein the LNB comprises a combiner that is operable to combine an output of the direct digital frequency synthesizer (DDFS) with an intermediate frequency signal to generate a channel signal having a corrected center frequency appropriate for output to a satellite receiver/decoder.

8. A system, comprising:
an integrated circuit that is operable to:
generate, based on quadricorrelator frequency error detection, frequency error related information from a digital baseband signal corresponding to a received satellite signal;
track frequency error of the digital baseband signal based on the generated frequency error related information; and
correcting, based on direct digital frequency synthesis, the tracked frequency error of the digital baseband signal.

9. The system of claim 8, wherein the integrated circuit is operable to obtain the digital baseband signal based on the received satellite signal.

10. The system of claim 9, wherein the integrated circuit is operable to obtain the digital baseband signal by converting an intermediate frequency signal corresponding to the received satellite television channel signal to the digital baseband signal.

11. A method, comprising:
in a low noise block (LNB):
generating quadricorrelator frequency error related information based on a digital baseband signal corresponding to a received satellite television signal;
tracking frequency error of the digital baseband signal via a phase locked loop based on the quadricorrelator frequency error related information; and
correcting the tracked frequency error of the digital baseband signal through a direct digital frequency synthesizer.

12. The method of claim 11, comprising, when correcting the tracked frequency error of the digital baseband signal, combining a frequency error word generated by the phase locked loop with a frequency control word for input to the direct digital frequency synthesizer.

13. The method of claim 11, wherein correcting the tracked frequency error of the digital baseband signal eliminates Dielectric Resonator Oscillator (DRO) frequency drift error to make available, a maximum number of output channels.

14. The method of claim 11, comprising applying via the phase locked loop an integration coefficient to the quadricorrelator error related information, wherein the integration coefficient determines a number of averaged frequency error related information in a frequency error term.

15. The method of claim 18, wherein the integration coefficient is predetermined, automatically selected, or user selected.

16. The method of claim 11, wherein the corrected digital baseband signal occupies a maximum bandwidth of 30 MHz.

17. The method of claim 11, wherein the corrected digital baseband signal is perfectly centroid.

18. The method of claim 11, wherein the corrected digital baseband signal prevents overlap of neighboring channels.

19. The method of claim 11, wherein the corrected digital baseband signal has no frequency error or negligible frequency error.

20. The method of claim 11, wherein the corrected digital baseband signal requires less bandwidth than a signal having an uncorrected center frequency.
